(19) United States
(12) Patent Application Publication
(10) Pub. No.: US 2005/0034125 A1
(43) Pub. Date: Feb. 10, 2005

(54) Multiple virtual devices

(75) Inventors: Gideon Guy, Chatsworth, CA (US); Eugenio Allevato, Northridge, CA (US)

Correspondence Address: SOCAL IP LAW GROUP, 310 N. WESTLAKE BLVD. STE 120, WESTLAKE VILLAGE, CA, 91362, US

(73) Assignee: Logicube, Inc.

(21) Appl. No.: 10/634,278

(22) Filed: Aug. 5, 2003

(51) Int. Cl. G06F 9/46

(52) U.S. Cl. 718/100

(57) ABSTRACT

Techniques for multiple virtual devices are disclosed. A method allowing for sharing a storage device among multiple users of a computing device may be implemented on a sharing device coupled with the computing device. The storage device may be a hard disk. The method may comprise receiving a storage device access command including a virtual device address, translating the virtual device address to a translated address, and forwarding to the storage device the access command with the translated address in place of the virtual device address. Users may designate multiple virtual devices and select an active virtual device for booting. The sharing device may be included in an add-on card, on a motherboard in the computing device, in the storage device, as part of the basic input output system chip of a computing device, and as a separate device between the storage device and the motherboard.

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to computing devices and the storage devices used therewith.

2. Description Of Related Art

Computers have become ubiquitous in modern society. Computers are used in homes, in offices, in schools, in automobile repair garages, in manufacturing facilities, and in many other places. In many of these places multiple users access the computers. Each of the multiple users may be given an account on the multiple user computer.

Most computers include a hard disk. The hard disk contains an operating system, multiple applications programs, and user data. The user data may include user customized settings, user preferences, user created documents, and other files created by or accessed by a particular user and created by or accessed by programs used by a particular user.

When multiple users use a single computer, different users may use different application programs. However, the installation and use of one user's application program may interfere with the application programs used by another user. Similarly, sensitive or personal data may be stored by a user of the multiple user computer which the user does not want other users to view or otherwise access. In addition, one user may alter the operating system or important system or configuration files, either intentionally or unintentionally, leaving the computer in an unusable or undesirable state for the other users. Further when a virus, worm or other malicious software or hacker attacks the multiple user computer, all users of the computer may be negatively affected.

### DESCRIPTION OF THE DRAWINGS

FIG. 1 is a block diagram of a first sharing device installed in a computer in accordance with the invention.

FIG. 2 is a block diagram of a second sharing device installed in a computer in accordance with the invention.

FIG. 3 is a block diagram of a third sharing device installed in a computer in accordance with the invention.

FIG. 4 is a block diagram of a fourth sharing device installed in a storage device coupled to a computer in accordance with the invention.

FIG. 5A is a block diagram of first panel in accordance with the invention.

FIG. 5B is a block diagram of second panel in accordance with the invention.

FIG. 6 is a block diagram of the contents of a hard disk in accordance with the invention.

FIG. 7 is a flow chart of the actions taken during boot up of a computer in accordance with the invention.

FIG. 8 is a flow chart of a first group of actions taken by a sharing device that implements multiple virtual devices in accordance with the invention.

FIG. 9 is a flow chart of a second group of actions taken by a sharing device that implements multiple virtual devices in accordance with the invention.

### DETAILED DESCRIPTION OF THE INVENTION

Throughout this description, the embodiments and examples shown should be considered as exemplars, rather than limitations on the invention.

Systems and Devices

The multiple virtual devices described herein allow for multiple users of a single computing device to have allocated to them a separate, secure virtual device of a storage medium on a storage device.

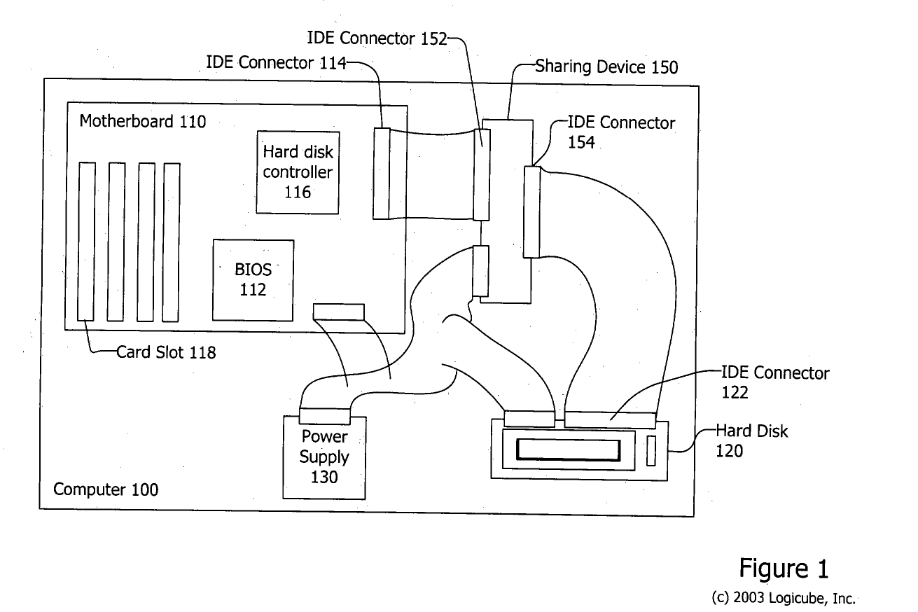

FIG. 1 is a block diagram of a first sharing device 150 installed in a computer 100 in accordance with the invention. The computer 100 may include a hard disk 120, a motherboard 110, and a power supply 130. The computer 100 may include other components which are not discussed herein.

The motherboard 110 of a computer 100 may have a hard disk controller 116 included thereon. The motherboard 110 may also include an Integrated Drive Electronics (IDE) connector 114 which is coupled to hard disk controller 116. The motherboard 110 includes a basic input output system (BIOS) chip 112 which, among other things, controls the boot up procedure of the computer 100. The motherboard 110 may include one or more card slots 118 or bays which may conform to any standards, such as for example, the peripheral component interconnect (PCI) standard, industry standard architecture (ISA) standard, and others. In one embodiment, a PCI card or other card having a hard disk controller included thereon may be included in one of the card slots 118 of the computer 100.

The hard disk 120 may conform to one or more hard disk standards. As used herein, “hard disk standards” include any version of the Advanced Technology Attachment (ATA) standards, including the ATA Packet Interface (ATAPI), ATA-2 and ATA/100, for example; IDE, Enhanced IDE (EIDE); their variants; and other hard disk standards. The hard disk may be an ATA/IDE compatible hard disk and/or may be compatible with other hard disk standards. The format of the hard disk may be any format, such as, for example, File Allocation Table 16 bit (FAT-16), FAT-32, new technology file system (NTFS), and Hierarchical File System (HFS).

The connectors 114, 122, 152 and 154 and related cables, which are described in more detail herein, may conform to any standard by which the hard disk 120 may be accessed, such as, for example, without limitation, any version of the hard disk standards as well as data transfer standards. As used herein, data transfer standards include USB, IEEE 1394, small computer system interface (SCSI), Fibre Channel, Ethernet, IEEE 802, and others.

The sharing device 150 may be coupled between the hard disk 120 and a motherboard 110. The sharing device 150 and the techniques described herein may be implemented as one or more field programmable gate arrays (FPGA), programmable logic units (PLU), application specific integrated circuits (ASIC) and/or other devices. The sharing device 150 may also include memory such as random access memory (RAM) or other memory. The sharing device 150 is capable of communicating with hard disk 120 and hard disk controller 116 via one or more hard disk standards and/or one or more data transfer standards. The sharing device 150 may be coupled via ribbon cables having IDE connectors 114, 122, 152 and 154 to the hard disk 120 and to the motherboard 110. The sharing device 150 may be installed at the factory by a manufacturer, at a distribution site by a distributor, at the point of sale by a seller, and at a place of use by an end user.

The sharing device 150 may include a management unit and a startup unit, and may maintain a virtual device table. The management unit, the startup unit, and the virtual device table may be hardware, software, firmware, or a combination thereof. Additional and fewer units, modules or other arrangement of software, hardware and data structures may be used to achieve the sharing device and multiple virtual devices described herein.

Power supply 130 supplies electrical power to the computer 100, including the motherboard 110, the hard disk 120, the sharing device 150, and other components which are not shown.

Hard disk 120 may be external to the computer 100. In this embodiment, the hard disk 120 and/or the sharing device 150 may receive electrical power from any readily available power source, or may receive power via the USB or other data transfer cables. When the hard disk 120 is external to the computer 100, it may be coupled by wires or cables to the computer 100, and may be connected wirelessly to the computer 100 via Wi-Fi, Bluetooth and other wireless techniques and standards.

Although sharing device 150 is shown in a computer, sharing device 150 may be coupled to any computing device. A computing device as used herein refers to any device with a processor that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the multiple virtual device techniques discussed herein are described with regard to a hard disk, the techniques may be implemented with any storage media in any; storage device included with or otherwise coupled or attached to a computing device. These storage media include, for example, floppy disks, optical disks such as compact disks (CD-ROM and CD-RW) and digital versatile disks (DVD and DVD±RW), magnetic tape, and solid state flash memory cards such as, for example, CompactFlash brand memory cards, flash memory drive devices, and any other storage media. As used herein, a storage device is a device that allows for reading and/or writing to a storage medium. A bootable storage device is a storage device which the BIOS of a computer may recognize as a bootable device, or a storage device which a computing device may recognize as a bootable device, whether located locally or remotely and internally or externally. A bootable storage device may have stored thereon or have a storage medium included therein which has stored thereon an operating system or other software from which a computing device may boot up or start functioning. The multiple virtual device techniques discussed herein are well suited to bootable storage devices.

Sharing device 150 may have multiple IDE connectors that allow multiple hard disk drives to be coupled to the sharing device 150. For example, the single hard disk may be replaced by or augmented with a group of one or more hard disks configured as Just a Bunch Of Disks (JBOD) or as a Redundant Array of Independent Disks (RAID). In these embodiments, the sharing device 150 may be constructed to support one or more data transfer standards by which the sharing device 150 may communicate with one or more hard disk drives or other storage devices that contain storage media.

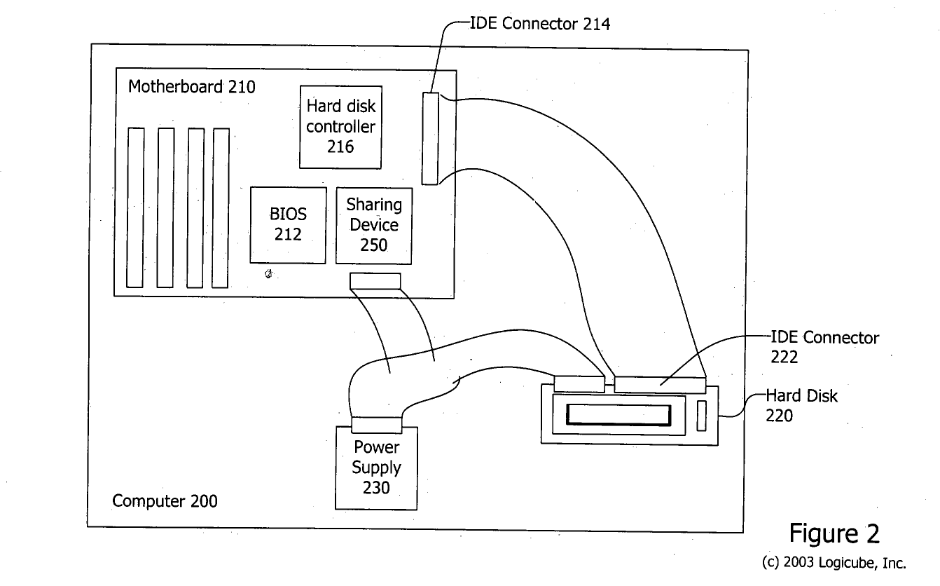

FIG. 2 is a block diagram of a second sharing device 250 installed in a computer 200 in accordance with the invention. The computer 200 may include a hard disk 220, a motherboard 210, and a power supply 230. The computer 200 may include other components. As many of the details of this embodiment are similar to those discussed with regard to FIG. 1, they are not repeated with the discussion of FIG. 2.

The motherboard 210 of a computer 200 may have a hard disk controller 216, a BIOS chip 212, and sharing device 250 included thereon. The motherboard 210 may also include an IDE connector 214 which is logically coupled to hard disk controller 216.

The sharing device 250 is typically installed at the factory by a manufacturer. The sharing device 250 may include or be one or more FPGAs, PLUs, or other devices. The sharing device 250 may include memory such as RAM, or other memory, and/or may access memory included on the motherboard 210. The sharing device 250 is logically coupled to the hard disk controller 216.

The sharing device 250 may include a startup unit and a management unit, and may maintain a virtual device table. The management unit, the startup unit, and the virtual device table may be hardware, software, firmware, or a combination thereof. Additional and fewer units, modules or other arrangement of software, hardware and data structures may be used to achieve the sharing device and multiple virtual devices described herein.

Hard disk 220 may be coupled to motherboard 210 via a ribbon cable between IDE connector 222 on the hard disk to IDE connector 214 on the motherboard 210. In a related embodiment, hard disk 220 may be external to the computer 200.

Power supply 230 supplies electrical power to the computer 200, including the motherboard 210, the hard disk 220, and other components which are not shown.

Although sharing device 250 is shown on the motherboard 210 of computer 200, sharing device 250 may be included in any computing device.

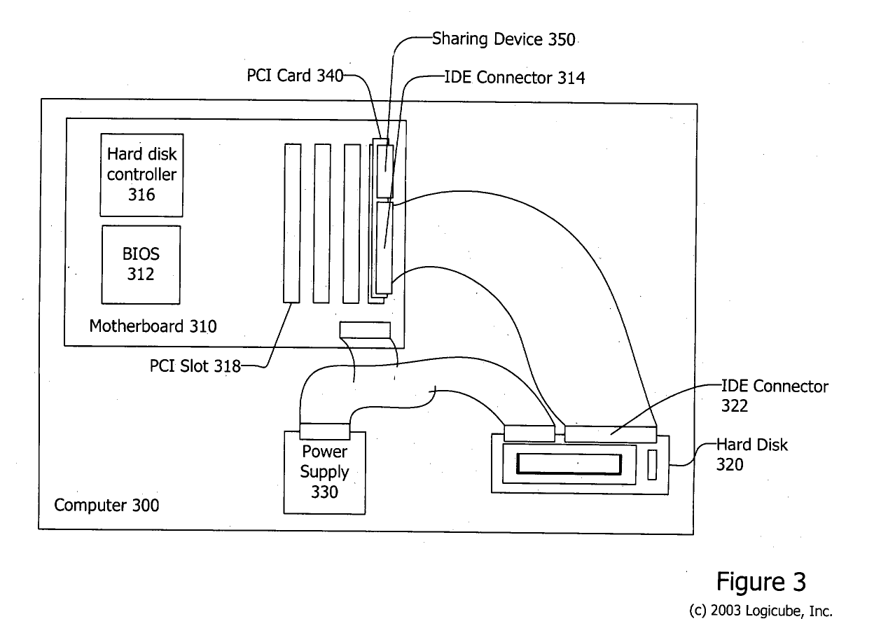

FIG. 3 is a block diagram of a third sharing device 350 installed in a computer 300 in accordance with the invention. The computer 300 may include a hard disk 320, a motherboard 310, and a power supply 330. The computer 300 may include other components which are not discussed herein. As many of the details of this embodiment are similar to those discussed with regard to FIGS. 1 and 2, they are not repeated with the discussion of FIG. 3.

The motherboard 310 may include a hard disk controller 316 and a BIOS chip 312. In addition, the motherboard may include one or more card or board slots 318 or bays that conform to any standards, such as, for example, without limitation, the PCI and the ISA standards.

PCI card 340 has a sharing device 350 and an IDE connector 314 included thereon. PCI card 340 may also have a hard disk controller 316 included thereon. PCI card 340 is coupled in a card slot 318 on motherboard 310. The PCI card 340 may be installed into computer 300 at the factory by a manufacturer, at a distribution site by a distributor, at the point of sale by a seller, and by an end user.

Hard disk 320 may be coupled to PCI card 340 via a ribbon cable between IDE connector 322 on the hard disk 320 and IDE connector 314 on the PCI card 340.

Sharing device 350 may be included on any plug-in card or add-on board to any computing device.

The sharing device 350 may include or be an FPGA, a PLU, or other device. The sharing device 350 may access memory included on the PCI card 340 and/or the motherboard 310. The sharing device 350 may include a management unit and a startup unit, and may maintain a virtual device table. The management unit, the startup unit, and the virtual device table may be hardware, software, firmware, or a combination thereof. Additional and fewer units, modules- or other arrangement of software, hardware and data structures may be used to achieve the sharing device and multiple virtual devices described herein.

Power supply 320 supplies electrical power to the computer 300, including the motherboard 310, the hard disk 320, and other components which are not shown.

Referring now to FIGS. 1, 2 and 3, a sharing device may be included in a BIOS chip or hard disk controller such as, for example, without limitation, the hard disk controllers 116, 216 and 316, and the BIOS chips 112, 212 and 312.

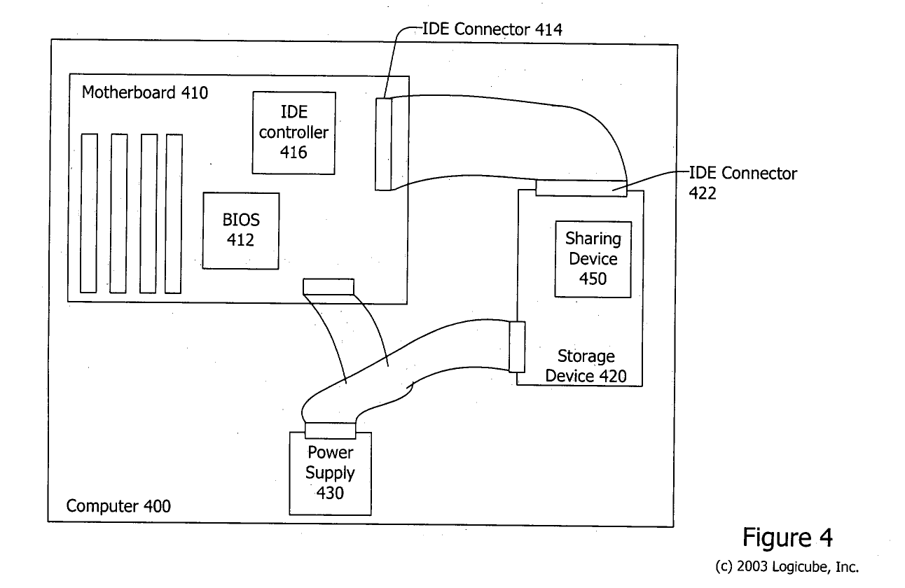

FIG. 4 is a block diagram of a fourth sharing device 450 installed in storage device 420 coupled to computer 400 in accordance with the invention. The computer 400 may include a storage device 420, a motherboard 410, and a power supply 430. The computer 400 may include other components. As many of the details of this embodiment are similar to those discussed with regard to FIG. 1, they are not repeated with the discussion of FIG. 4.

The motherboard 410 of computer 400 may have an IDE controller 416, and a BIOS chip 412. The motherboard 410 may also include an IDE connector 414 which is logically coupled to IDE controller 416.

Storage device 420 may be coupled to motherboard 410 via a ribbon cable between IDE connector 422 on the storage device to IDE connector 414 on the motherboard 410. In a related embodiment, storage device 420 may be external to the computer 400.

The sharing device 450 may be coupled with or otherwise included in the storage device 420. The sharing device 450 may be physically and/or logically coupled to the storage device 420. The sharing device 450 may include or be one or more FPGAs, PLUs, or other devices. The sharing device 450 may include memory such as RAM, or other memory. The sharing device 450 may include a virtual device table and may include or be hardware, software, firmware, or a combination thereof. Various software units, software modules or other arrangement of software, firmware, hardware and data structures may be used to achieve the sharing device and multiple virtual devices described herein.

Although sharing device 450 is shown coupled with storage device 420, the sharing device 450 may be included in any storage device.

Power supply 430 supplies electrical power to the computer 400, including the motherboard 410, the storage device 420, and other components which are not shown.

User Interfaces And Panels

According to the various embodiments of the multiple virtual devices, user input is required to define and/or designate one or more virtual devices and to designate an active virtual device. An active virtual device is that virtual device from which the computing device will boot when next powered on or restarted.

In some of the embodiments of the multiple virtual devices, a panel may be added to a computer to allow a user to select which of the multiple virtual devices should be the active virtual device. The sharing device may receive a user selection of the active virtual device from the panel.

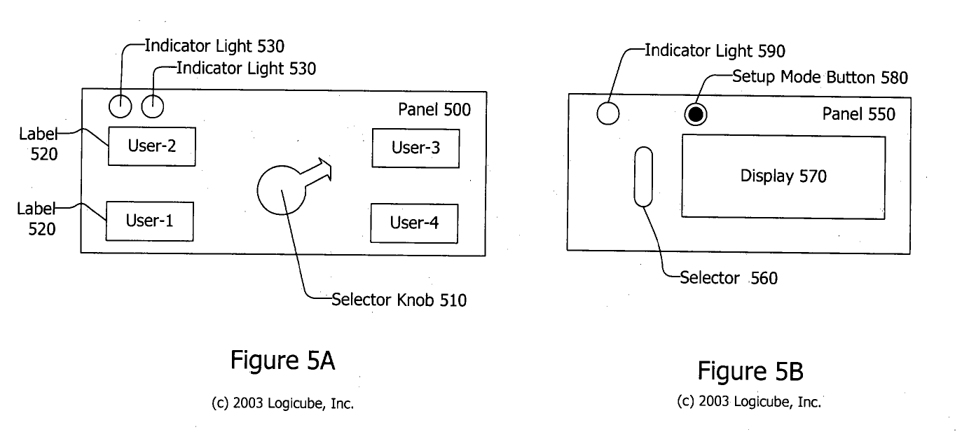

FIG. 5A is a block diagram of first panel 500 in accordance with the invention. Panel 500 includes a selector knob 510 which a user moves to select from which defined virtual device the computer should boot. The knob 510 may be any device which allows a user to indicate which virtual device should be used for booting. Labels 520 may be pre-printed numbers, letters or other information identifying the virtual devices. Labels 520 may be written on by users to name or otherwise identify the virtual devices. The labels 520 may be any number that fits on the panel 500. In the example shown, there are four labels 520. The panel 500 may also include indicator lights 530 to signify whether a hard disk or other storage device is being accessed, is powered on, is on-line, and the like. Although two indicator lights 530 are shown none or more may be included on panel 500.

FIG. 5B is a block diagram of second panel 550 in accordance with the invention. Panel 550 includes a selector device 560 which may be a wheel. Panel 550 also includes a display 570 which may be a liquid crystal display (LCD) device, thin film transistor (TFT), or other display for displaying text to a user. When the virtual devices have already been assigned, a user may use the selector 560 to indicate from which of the virtual devices displayed on display 570 the computer should boot. The user may make this selection before or during boot up.

The panel 550 may include a setup mode button 580. When setup mode button 580 is pressed by a user, the management unit of the sharing device may provide a multiple virtual devices user management interface that allows a user to create, add, delete, name or otherwise maintain virtual devices on a hard disk drive or other storage device. In various embodiments, the management interface may be provided on the display 570 and/or on a display that is part of a computer system. User input during the setup process may be received via a combination of the selector 560 and/or one or more of a keyboard or other user input device (e.g., mouse, trackball, glove, pen) connected to the computer.

The indicator light 590 is similar to the indicator light 530 discussed above regarding FIG. 5A.

In some embodiments, a setup mode button like setup mode button 580 may be added to panel 500.

Panels having some, all, or similar functionality to panels 500 and 550 described above in FIGS. 5A and 5B may be included in desktop personal computers, tower computers, computer workstations and other computing devices. A panel such as these may be on the front or face of a computing device adjacent to a face plate or front panel of a hard disk drive, CD-ROM, DVD or other storage device. Similar panels or the functionality of the panels may be added to any computing devices.

In other embodiments, a panel is not needed as the startup unit uses the display on the computer or other computing device to alert the user during boot up which virtual device is being used. The management unit may also use the display on the computer or other computing device to provide the management interface.

In one embodiment, the management interface allows a user to define a number of virtual devices and their size. A name or other identifier may be assigned to each virtual device by the user. Each virtual device may be bootable and may contain the operating system, application programs and other software provided with the computer. Use of a sharing device described herein makes each of the virtual devices separate and secure from the other virtual devices. The sharing device serves as a hardware firewall between the virtual devices of the hard disk. Separating virtual devices of a hard disk drives as described herein prevents viruses, worms, and other malicious software from traveling between virtual devices. In this way, when one virtual device is infected by or otherwise harmed by a virus, worm or other malicious software, the remaining virtual devices are unaffected.

In one embodiment, the management interface may also allow a user to create one or more shared virtual devices. A shared virtual device may be accessed as a logically separate disk drive when a user boots from a virtual device. The shared virtual device allows for the exchange of files between users of different virtual devices.

In one embodiment, access to the virtual devices may be allowed only upon the entering of a password or other authenticating or security technique. A default password may be assigned to each virtual device. The first time a user boots from a virtual device, the startup software may require that the user change the password. In another embodiment, the initial user of a computer having a sharing device may create each virtual device with a password provided by the intended user of the virtual device.

Storage Device Contents

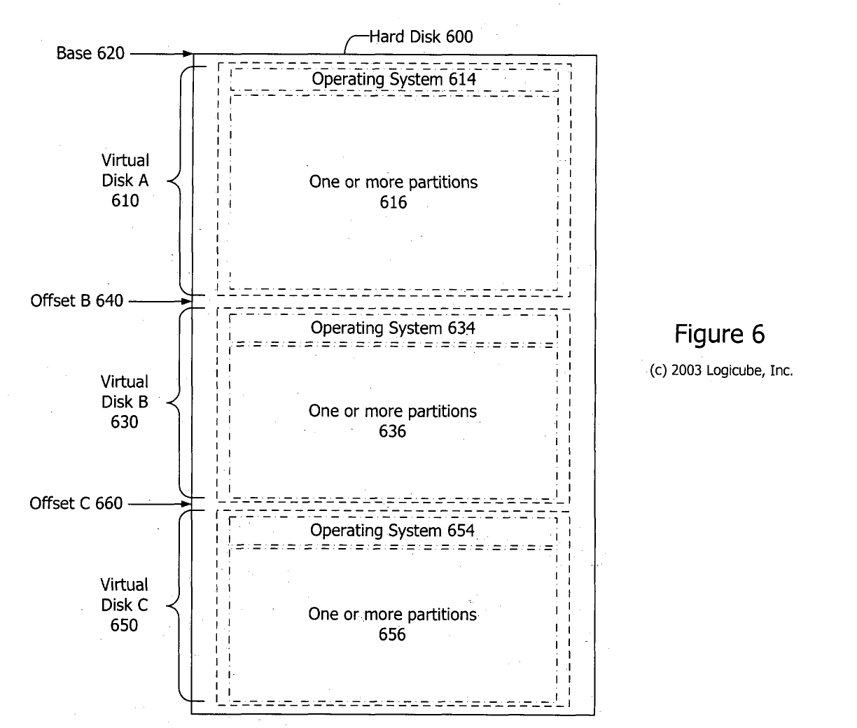

FIG. 6 is a block diagram of the contents of hard disk 600 in accordance with the invention When multiple virtual devices are created using a sharing device, the sharing device maintains information used to access and maintain the virtual devices. When the virtual devices are created on a hard disk such as hard disk 600, the sharing device maintains location information and size information of each of the virtual hard disks. The size information may be in Mbytes, GBytes, or other size designation. The location information may be a base address 620 such as the number 0 or other address, and offsets or addresses such as offset B 640 and offset 660. Each of the base 620, offset B 640 and offset C 660 define the position on the hard disk 600 where virtual disk A 610, virtual disk B 630 and virtual disk C begin. Although FIG. 6 depicts three virtual disks, more and fewer virtual disks may be included in hard disk 600.

As shown in FIG. 6, each of the virtual disks 610 include an operating system 614, 634 and 654. The operating system may be the same or different for each virtual disk. In one embodiment, at least one of the virtual disks 610, 630 and 650 must include an operating system so that the computer to which the hard disk is attached may start up and be usable. Each of the virtual disks 610, 630 and 650 may have any number of partitions included therein as allowed by and controlled by the operating system resident on the particular virtual hard disk. Application programs, program data, user created files, and other information may be stored on the one or more partitions 616, 636 and 656 of each of the virtual disks 610, 630 and 650.

As an active virtual device is that virtual device from which the computing device will boot when next powered on or restarted, it follows that an active virtual disk is that virtual disk that a user selects as being the virtual disk from which the computer may boot. In one embodiment, when a computer boots from a user specified virtual disk, only that virtual disk is visible to the user of the computer. For example, if virtual disk B is the active virtual disk, when a computer having hard disk 600 included therein is booted, the sharing device ensures that the user only has access to the portion of hard disk 600 between offset B 640 and offset C 660. The operating system 634 will only show that there is a single hard disk attached to the computer having the size associated with virtual disk B 630.

Methods

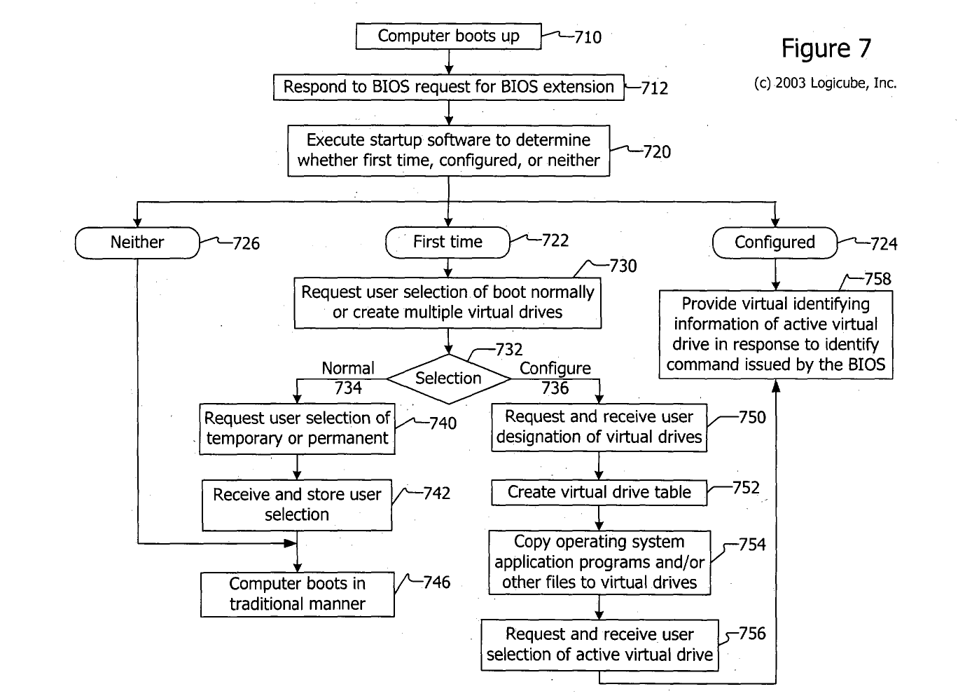

FIG. 7 is a flow chart of actions taken to boot up a computer in accordance with the invention. When a computer or other computing device boots up, as shown in block 710, the BIOS checks for whether any BIOS extensions or BIOS option ROMS are included in any devices includes in or attached to the computer. The multiple virtual devices implementation as a sharing device may include startup software that is executed upon boot up as a BIOS extension. The sharing device may include a BIOS option ROM. The sharing device responds to the BIOS extension query, as shown in block 712. The sharing device then determines whether the computer is being booted for the first time, already has multiple virtual devices assigned, or neither, as shown in block 714.

If the computer is being booted for the first time, as shown in block 722, the sharing device requests that the user select to boot normally or to create multiple virtual devices, as shown in block 730. A check is then made to determine what the user selected, as shown in block 732.

When the user selects to boot normally, 734, a request is made to learn whether the user would like to boot normally once, that is, temporarily, or whether the user would like to always, that is, permanently, boot normally, as shown in block 740. Permanent selection of booting normally effectively disables the multiple virtual devices functionality. Temporary selection causes the computer on next boot to behave as if it was booting for the first time. The user selection is received and stored, as shown in block 742. Control is then returned to the BIOS, and the computer boots in its traditional manner, as shown in block 746.

When the user selects to configure a storage device, 736, the sharing device requests and receives user designations of virtual devices, as shown in block 750. The operating system, application programs, and other files and programs are copied to each of the virtual devices, as shown in block 752. A virtual device table is created, as shown in block 754. The virtual device table may include identifying information about each virtual device, including its location on the disk and the size of the virtual device. A user selection of an active virtual device of the multiple virtual devices is requested and received, as shown in block 756. Control of the computer is returned to the BIOS. The sharing device receives and responds to an “identify” command issued by the BIOS, providing translated identifying information to the BIOS, as shown in block 758. The translated identifying information may include the size of the active virtual device, referred to herein as the virtual size. The sharing device reports the virtual size to the BIOS as being the size of the active virtual device. The virtual size does not typically correspond to the real size of the hard disk or other storage device where the active virtual device is physically located. The computer then boots from the active virtual device as if it were a real hard disk or other bootable storage device.

During the booting up of a computer, the BIOS automatically detects bootable devices. A bootable device may be referred to as an initial program load (IPL) device. To detect storage devices, the BIOS issues an “identify” command to all storage devices, such as a hard disk drive. Hard disks respond to the “identify” command with hard disk identifying information. The hard disk identifying information includes physical and other information about the hard disk, such as the number of cylinders, the number of heads, the number of sectors per track, the total number of sectors on the hard disk, and may include other information. The sharing device prepares hard disk identifying information for each of the multiple virtual devices and stores this information in the virtual device table. In response to the identify command issued by the BIOS, the sharing device will provide identifying information for the virtual device in an altered form, defining the portion of the real disk drive that corresponds to the active virtual device.

The sharing device presents some of the identifying information describing the capabilities of the hard disk to the BIOS unaltered. The unaltered information may include the number of sectors per track, and whether the hard disk supports direct memory access (DMA) or programmed input output (PIO) modes of data transfer. The sharing device translates much of the identifying information of the hard disk and of the active virtual device into virtual identifying information before it is presented to the BIOS. For example if the hard disk is 80 GByte, and four 20 GByte virtual devices are created, the virtual information may state that that the size of the drive is 20 GBytes, and that the total number of sectors and the maximum number of sectors is approximately 40,000,000. That is, the size is reported as 20 GBytes and not 80 GBytes. When the “identify” command is issued by the BIOS, the sharing device responds with the virtual hard disk identifying information for the active virtual device.

The virtual device table is used to map the active virtual disk to a portion of a real hard disk. It is which is the active virtual disk which is recognized and known to the BIOS. The virtual hard disk identifying information allows for the operating system and application programs to issue disk access requests to the active virtual device. As the sharing device uses the virtual device table to map the active virtual device to a portion of a real hard disk, it is impossible for users of the computer to access information on the hard disk other than the active virtual device. Users of the computer, the operating system, the BIOS and application programs all have no knowledge of the real hard disk and no way to access the real hard disk. In this way, the sharing device serves as a hardware firewall that restricts access to all portions of the hard disk other than the active virtual device.

In a related embodiment, one or more other non-bootable shared virtual devices may also be found by the BIOS during boot up. In these embodiments, the active virtual device may be considered a master disk (or device) and the one or more shared virtual devices may be considered slave disks (or devices).

Returning now to FIG. 7, if the computer already has a bootable storage device with a storage medium having multiple virtual devices, as shown in block 724, the sharing device receives and responds to an identify command issued by the BIOS. The sharing device provides virtual hard disk identifying information of the active virtual device to the BIOS in response to the identify command, as shown in block 758. The virtual hard disk identifying information includes the size of the active virtual device, and a virtual address of the location of the active virtual device. The computer then boots, accessing the active virtual device by specifying the virtual address.

In some embodiments, the sharing device may boot from the active virtual device so long as the user does not interrupt execution of the sharing device during boot up. More specifically, during boot up, the sharing device may give the user a defined period of time within which to interrupt booting from the active virtual device. The interruption may be achieved in various ways, such as, for example, by hitting a particular keyboard combination, entering a particular key, pressing a setup mode button 580 on a panel like panel 550. The user may then be prompted to select which virtual device should be designated as the active virtual device. Authentication by a password, biometric data or other secure technique may be required for changing the designation of the active virtual device.

If the hard disk has not been virtually configured as described herein, and it is not being configured for the first time, the check of block 720 results in “neither”, as shown in block 726. In this circumstance, control of the computer is returned to the BIOS, and the computer boots in its traditional manner, as shown in block 746. This occurs when the user earlier permanently opted out of the multiple virtual devices features.

The actions described with regard to FIG. 7 may be achieved by a startup unit of a sharing device.

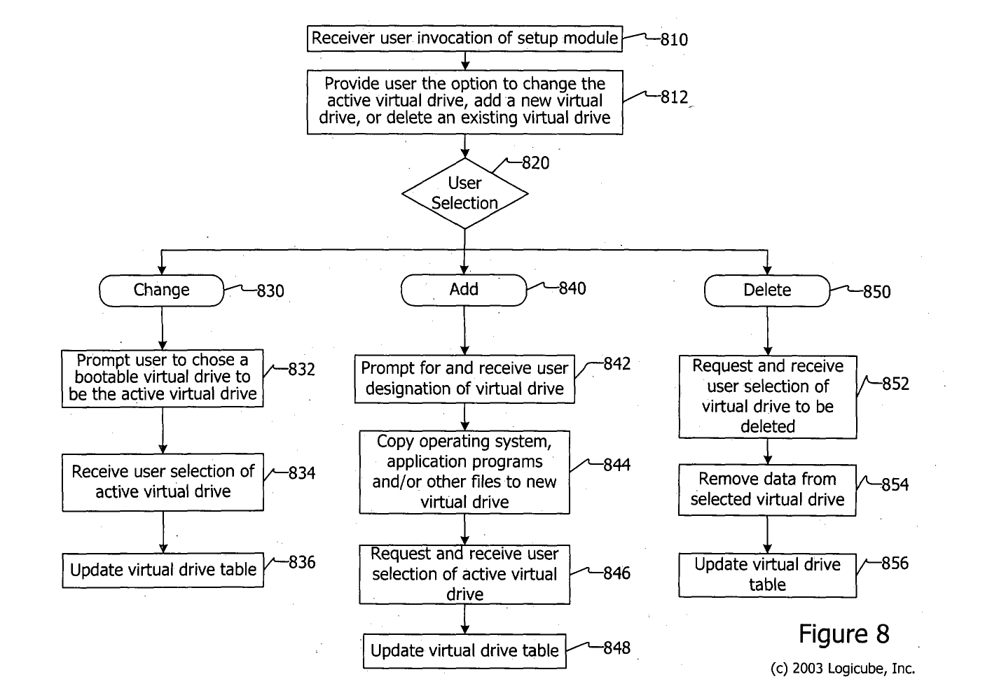

FIG. 8 is a flow chart of a first group actions taken by a sharing device that implements multiple virtual devices in accordance with the invention. The actions set forth in this flow chart begin when a user invokes the sharing device. The sharing device may be invoked by a user by pressing a setup mode button on a panel such as panels 500 and 550 described above regarding FIGS. 5A and 5B, by interrupting the boot up sequence and selecting setup, by invoking a key sequence when the computer is on, and in other ways. The sharing device receives the user invocation of the setup mode, as shown in block 810. The sharing device provides the user the option to change the active virtual device, add a new virtual device, or delete an existing virtual device, as shown in block 812. The sharing device then proceeds based on the user selection, as shown in block 820.

When the user selects to change the active virtual device from one virtual device to another, as shown in block 830, the sharing device prompts the user to chose which of the virtual devices should be the active virtual device, as shown in block 832. This may be achieved using any user interface techniques. One example technique is providing a text listing of all virtual devices, and allowing a user to use a scroll wheel and/or arrow keys to move a highlighted portion to select a desired virtual device. In one embodiment, a graphical icon is associated with each virtual device, and the user selects the active virtual device by clicking on an icon with a mouse or activating another user input device. The sharing device then receives this selection, as shown in block 834. The sharing device may then update an internal data structure such as a virtual device table to reflect the chosen active virtual device, as shown in block 836.

When the user selects to add a virtual device, as shown in block 840, the sharing device prompts the user to designate a virtual device and receives this designation, as shown in block 842. The designation may include a name or other identifier of the virtual device and a size of the virtual device. The designation may also include other information. The sharing device then copies the operating system and other system files to the new virtual device, as shown in block 844. In one embodiment, the sharing device may allow a user to define a virtual device as shared and not bootable. The sharing device requests and receives a user selection of an active virtual device, as shown in block 846. The virtual device table is updated to reflect the new virtual device and the active virtual device, as shown in block 848.

When the user selects to delete a virtual device, as shown in block 850, the sharing device requests and receives a user selection of a virtual device to be deleted, as shown in block 852. Data from the selected virtual device is removed, as shown in block 854. The virtual device table is updated to reflect the deletion of the selected virtual device, as shown in block 856.

Other user options may include move, edit or otherwise modify or redefine one or more of the virtual devices. More and fewer user options may be provided, and the functionality of the options may be combined or further separated.

The actions described with regard to FIG. 8 may be achieved by a management unit of a sharing device.

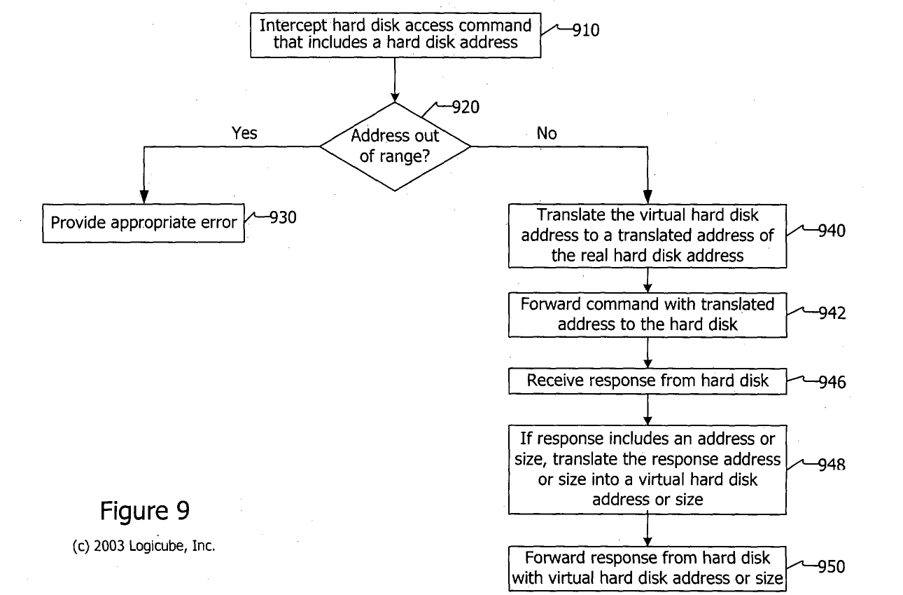

FIG. 9 is a flow chart of a second group of actions taken by a sharing device that implements multiple virtual devices in accordance with the invention. The actions set forth in this flow chart occur in a sharing device whenever any access attempts are made to the hard disk or other storage device included in a computing device. The access attempts may be made by the BIOS, by the operating system, by an application program, or any other software executing on a computing device. The sharing device intercepts hard disk access commands the computer or other computing device directs to a hard disk, as shown in block 910. The hard disk access command may specify a hard disk address. The sharing device checks to see if the hard disk address is out of range, as shown in block 920.

If the address is out of an acceptable range, an appropriate error is returned, as shown in block 930. The error may be an error code or other information mandated by a hard disk standard such as, for example, the ATA standard.

If the virtual hard disk address specified with the hard disk access command is within the acceptable range, as shown in block 920, the sharing device translates the virtual hard disk address to translated real address of the hard disk which corresponds to where the active virtual device is located, as shown in block 940. This translation may be achieved by referring to the virtual device table. The translation may be achieved by adding or subtracting an offset or base address of the active virtual device to the virtual hard disk address specified with the hard disk access command. The translation may be performed in real-time so that a delay in a user's accessing the hard disk drive is not detected.

The command is forwarded to the hard disk with the translated address specified in place of the intercepted virtual hard disk address, as shown in block 942. A response may be received from the hard disk, as shown in block 946. If the response includes a hard disk address or size, the hard disk address or size contained in the response is translated so that it conforms to the virtual address or size expected by the computer, as shown in block 948. As with the translating of the hard disk access command, the translation may be achieved by referring to the virtual device table. The translation may be achieved by adding or subtracting an offset or base address of the active virtual device from the hard disk address or size included with the response from the hard disk. The translation may be performed in real-time so that a delay in a user's accessing the hard disk drive is not detected. The response from the hard disk is forward to the computer with the translated address, if any, as shown in block 950.

Although described herein in some instances with regard to hard disk drives, the multiple virtual device techniques described herein may be applied to any storage device.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

1. A method for sharing a hard disk among multiple users of a computer, the method implemented on a sharing device coupled to the computer, the method comprising:
receiving a hard disk access command including a virtual hard disk address
translating the virtual hard disk address to a translated address
forwarding to the hard disk the access command with the translated address in place of the hard disk address.

2. The method of claim 1 further comprising:
receiving a response to the access command from the hard disk
if the response includes a hard disk address, translating the hard disk address into a virtual disk address
forwarding the response with the virtual disk address in place of the hard disk address.

3. The method of claim 2 further comprising:
if the response includes a hard disk size, translating the hard disk size into a virtual disk size
forwarding the response with the virtual disk size in place of the hard disk size.

4. The method of claim 1 wherein the translating comprises:
mapping the virtual hard disk address to a real hard disk address.

5. The method of claim 4 wherein the mapping comprises:
referring to a virtual device table.

6. The method of claim 1 wherein the translating comprises:
adding an offset to the virtual hard disk address based on virtual device identifying information stored in a virtual device table.

7. The method of claim 2 wherein the translating the hard disk address comprises:
mapping the response address to the virtual address by referring to a virtual device table.

8. The method of claim 2 wherein the translating the hard disk address comprises:
subtracting an offset from the response address based on identifying information of an active virtual device.

9. The method of claim 8 wherein the subtracting comprises:
referring to: a virtual device table.

10. The method of claim 1 wherein the sharing device is one of a field programmable gate array (FPGA), a programmable logic unit (PLU), an application specific integrated circuit (ASIC).

11. The method of claim 1 wherein the sharing device is coupled between the hard disk and a motherboard of the computer.

12. The method of claim 1 wherein the sharing device is coupled to a motherboard included in the computer.

13. The method of claim 1 wherein the sharing device is included on a card to be coupled to a card slot in the computer.

14. A method for sharing a hard disk among multiple users of a computer, the method implemented on a sharing device coupled to the computer, the method comprising:
when booting for a first time,
allowing a user to designate multiple virtual devices
creating a virtual device table including identifying information for each of the virtual devices
copying an operating system and application programs to each of the virtual devices on the hard disk.

15. The method of claim 14 further comprising:
allowing the user to select an active virtual device from the virtual devices
updating the virtual device table based on the user selection of the active virtual device.

16. The method of claim 14 wherein the sharing device is one of a field programmable gate array (FPGA), a programmable logic unit (PLU), an application specific integrated circuit (ASIC).

17. The method of claim 14 wherein the sharing device is coupled between the hard disk and a motherboard of the computer.

18. The method of claim 14 wherein the sharing device is coupled to a motherboard included in the computer.

19. The method of claim 14 wherein the sharing device is included on a card to be coupled to a card slot in the computer.

20. A sharing device to be coupled with a computing device having a hard disk, the sharing device having instructions stored thereon which when executed cause the sharing device to perform operations comprising:
receiving a hard disk access command including a hard disk address
translating the hard disk address to a translated address
forwarding to the hard disk the access command with the translated address in place of the hard disk address.

21. The sharing device of claim 20 having further instructions which when executed cause the sharing device to perform operations comprising:
receiving a response to the access command from the hard disk
if the response includes a response address, translating the response address into a virtual address
forwarding the response and the virtual address.

22. The sharing device of claim 20 wherein the translating comprises:
mapping the hard disk address to an active virtual device address.

23. The sharing device of claim 22 wherein the mapping comprises:
referring to a virtual device table.

24. The sharing device of claim 20 wherein the translating comprises:
adding an offset to the hard disk address based on identifying information of an active virtual device.

25. The sharing device of claim 24 wherein the adding comprises:
referring to a virtual device table.

26. The sharing device of claim 21 wherein the translating the response address comprises:
mapping the response address to the virtual address by referring to a virtual device table.

27. The sharing device of claim 21 wherein the translating the response address comprises:
subtracting an offset from the response address based on identifying information of an active virtual device.

28. The sharing device of claim 27 wherein the subtracting comprises:
referring to a virtual device table.

29. The sharing device of claim 20 wherein the sharing device includes at least one of a field programmable gate array (FPGA), a programmable logic unit (PLU), an application specific integrated circuit (ASIC).

30. The sharing device of claim 20 wherein the sharing device is coupled between the hard disk and a motherboard of the computing device.

31. The sharing device of claim 20 wherein the sharing device is coupled to a motherboard included in the computing device.

32. The sharing device of claim 20 wherein the sharing device is included on a card to be coupled to a card slot in the computing device.

33. A sharing device to be coupled with a computing device having a hard disk, the sharing device having instructions stored thereon which when executed cause the sharing device to perform operations allowing for sharing the hard disk among multiple users of the computing device, the operations comprising:
when booting for a first time,
allowing a user to designate multiple virtual devices
creating a virtual device table including identifying information for each of the virtual devices
copying an operating system and application programs to each of the virtual devices on the hard disk.

34. The sharing device of claim 33 having further instructions which when executed cause the sharing device to perform operations comprising:
allowing the user to select an active virtual device from the virtual devices
updating the virtual device table based on the user selection of the active virtual device.

35. The sharing device of claim 33 wherein the sharing device is one of a field programmable gate array (FPGA), a programmable logic unit (PLU), an application specific integrated circuit (ASIC).

36. The sharing device of claim 33 wherein the sharing device is coupled between the hard disk and a motherboard of the computing device.

37. The sharing device of claim 33 wherein the sharing device is coupled to a motherboard included in the computing device.

38. The sharing device of claim 33 wherein the sharing device is included on a card to be coupled to a card slot in the computing device.

39. The sharing device of claim 33 wherein the sharing device is included on the hard disk.

40. A method for sharing a storage device among multiple users of a computing device, the method implemented on a sharing device coupled to the computing device, the method comprising:
receiving a storage device access command including a virtual device address
translating the virtual device address to a translated address
forwarding to the storage device the access command with the translated address in place of the storage device address.

41. The method of claim 40 further comprising:
receiving a response to the access command from the storage device
if the response includes a storage device address, translating the storage device address into a virtual device address
forwarding the response with the virtual device address in place of the storage device address.

42. The method of claim 41 further comprising:
if the response includes a storage device size, translating the storage device size into a virtual device size
forwarding the response with the virtual device size in place of the storage device size.

43. The method of claim 40 wherein the translating comprises:
mapping the virtual device address to a real storage device address.

44. The method of claim 43 wherein the mapping comprises:
referring to a virtual device table.

45. The method of claim 40 wherein the translating comprises:
adding an offset to the virtual device address based on virtual device identifying information stored in a virtual device table.

46. The method of claim 41 wherein the translating the storage device address comprises:
mapping the response address to the virtual address by referring to a virtual device table.

47. The method of claim 41 wherein the translating the storage device address comprises:
subtracting an offset from the response address based on identifying information of an active virtual device.

48. The method of claim 47 wherein the subtracting comprises:
referring to a virtual device table.

49. The method of claim 40 wherein the sharing device is one of a field programmable gate array (FPGA), a programmable logic unit (PLU), an application specific integrated circuit (ASIC).

50. The method of claim 40 wherein the sharing device is coupled between the storage device and a motherboard of the computing device.

51. The method of claim 40 wherein the sharing device is coupled to a motherboard included in the computing device.

52. The method of claim 40 wherein the sharing device is included on a card to be coupled to a card slot in the computing device.

53. The method of claim 40 wherein the sharing device is included in the storage device.

54. The method of claim 40 wherein the storage device is a hard disk drive.

55. A method for sharing a storage device among multiple users of a computing device, the method implemented on a sharing device coupled to the computing device, the method comprising:
when booting for a first time,
allowing a user to designate multiple virtual devices from the storage device
creating a virtual device table including identifying information for each of the virtual devices
copying an operating system and application programs to each of the virtual devices on the storage device.

56. The method of claim 55 further comprising:
allowing the user to select an active virtual device from the virtual devices
updating the virtual device table based on the user selection of the active virtual device.

57. The method of claim 55 wherein the sharing device is one of a field programmable gate array (FPGA), a programmable logic unit (PLU), an application specific integrated circuit (ASIC).

58. The method of claim 55 wherein the sharing device is coupled between the storage device and a motherboard of the computing device.

59. The method of claim 55 wherein the sharing device is coupled to a motherboard included in the computing device.

60. The method of claim 55 wherein the sharing device is included on a card to be coupled to a card slot in the computing device.

61. The method of claim 55 wherein the sharing device is included in the storage device.

62. The method of claim 55 wherein the storage device is a hard disk drive.
